(19) United States
(12) Patent Application Publication
(10) Pub. No.: US 2014/0267636 A1
(43) Pub. Date: Sep. 18, 2014

(54) VIRTUAL IMAGE DISPLAY DEVICE

(71) Applicant: SEIKO EPSON CORPORATION, Tokyo (JP)

(72) Inventors: Masayuki TAKAGI, Matsumoto-shi (JP); Takahiro TOTANI, Suwa-shi (JP); Takashi TAKEDA, Suwa-shi (JP); Akira KOMATSU, Tatsuno-machi (JP); Toshiaki MIYAO, Matsumoto-shi (JP)

(73) Assignee: SEIKO EPSON CORPORATION, Tokyo (JP)

(21) Appl. No.: 14/166,405

(22) Filed: Jan. 28, 2014

(30) Foreign Application Priority Data
Mar. 12, 2013 (JP) 2013-048837

(51) Int. Cl. H04N 13/04; G02F 1/1333

(52) U.S. Cl. CPC H04N 13/0497; H04N 13/044; G02F 1/1333
USPC 348/53

(57) ABSTRACT

An image display device performs control to provide light distribution characteristics in which a light distribution angle is wider in a horizontal direction corresponding to a lateral direction parallel to a direction in which eyes of an observer are arranged, rather than in a vertical direction corresponding to a longitudinal direction perpendicular to the direction in which the eyes of the observer are arranged, to thus obtain a state where the light distribution angle is wider in the horizontal direction, and the occurrence of a luminance difference by an emission angle of video light related to the horizontal direction can be suppressed. That is, it is possible to observe a good image in which the luminance of video light is adjusted and to reduce fatigue in the observer.

### BACKGROUND

1. Technical Field

The present invention relates to a virtual image display device which presents a video formed by an image display element or the like to an observer, and particularly, to a virtual image display device suitable for a head-mounted display which is mounted on the head of the observer.

2. Related Art

Various systems have been proposed as an optical system which is incorporated in a virtual image display device such as a head-mounted display (hereinafter, also referred to as HMD) which is mounted on the head of an observer. (for example, JP-A-2012-27350).

As for virtual image display devices such as a HMD, it is desirable to increase an angle of view of video light and to reduce device weight.

In virtual image display devices, in order to visually recognize a good image, it is important to secure a certain degree or higher than the certain degree of luminance in a horizontal direction in which eyes are arranged within a specific angle range. However, for example, it is also necessary to reduce a size of a video element configured to have a liquid crystal panel or the like when reducing the whole device in size, and the smaller the display pixels of the video element, the narrower the angle range in which the luminance is maintained in or higher than a specific range. In addition, it can also be grasped that the narrowing of the viewing angle characteristics occurs because a light distribution angle which is determined based on a video element or the like such as a backlight is narrowed. As described above, when the luminance of video light is not secured and a luminance difference occurs, luminance of a video on the right side and luminance of a video on the left side become different from each other in the case of a virtual image display device of a type where right and left eyes are used in binocular vision. Thus, an observer may feel uncomfortable or may feel fatigued easily.

JP-A-2012-27350 proposes to provide a prism optical system which has a small size and a light weight using a prism using four surfaces including a rotational asymmetric surface, and has a high degree of freedom in shape. However, when the size is small as in JP-A-2012-27350, it is difficult to secure the luminance of video light as described above and the range in which the video light can be captured is restricted. Accordingly, a change in luminance of video light due to a difference in eye position is also easily increased. That is, the luminance of video light easily changes, and thus when both right and left eyes are used to observe, the video may be seen very differently in terms of luminance on the right side and on the left side.

### SUMMARY

An advantage of some aspects of the invention is to provide a virtual image display device which allows observation of a good image with adjusted luminance and can reduce fatigue in an observer.

An aspect of the invention is directed to a virtual image display device including a video element which generates video light and a light guide member which guides the video light from the video element, in which the video element emits the video light after controlling light distribution characteristics thereof to a state where a light distribution angle is large, rather than in a vertical direction corresponding to a longitudinal direction perpendicular to a lateral direction in which eyes of an observer are arranged, in the horizontal direction corresponding to the lateral direction.

In the virtual image display device, the light distribution angle is adjusted to be large in a horizontal direction which is a lateral direction (right-left direction) parallel to a direction in which eyes of an observer are arranged, rather than in a vertical direction which is a longitudinal direction (up-down direction) perpendicular to the direction in which the eyes of the observer are arranged, and thus a difference in luminance (luminance difference) which occurs by an emission angle of the video light related to the horizontal direction can be suppressed. That is, by taking a balance in the light distribution between the lateral and longitudinal directions, it is possible to observe a good image in which the luminance of video light is adjusted and to reduce fatigue in the observer.

In a specific aspect of the invention, a pixel of the video element is shaped to be large in a second direction corresponding to the horizontal direction rather than in a first direction corresponding to the vertical direction. In this case, the spread of the video light can be adjusted for each pixel.

In another specific aspect of the invention, the video element is a liquid crystal display device which forms video light by spatially modulating illumination light, and display pixels of the liquid crystal display device have an opening-shaped portion which is wide in the second direction rather than in the first direction. In this case, desired light distribution characteristics can be obtained by adjusting the opening-shaped portions of the liquid crystal display device.

In another specific aspect of the invention, in the liquid crystal display device, the display pixel constitutes a color filter-type pixel including at least three sub-pixels of R, G, and B, and the three sub-pixels have an opening-shaped portion which is wide in the second direction rather than in the first direction, and are arranged in the first direction. In this case, the three sub-pixels of R, G, and B are long in the lateral direction (second direction) and are arranged in the longitudinal direction (first direction) to constitute one pixel, and thus each color light has desired light distribution characteristics and the pixel can be formed to have a square shape or a shape similar thereto.

In another specific aspect of the invention, the virtual image display device further includes an illumination device which generates illumination light having light distribution characteristics in which a light distribution angle is large in the second direction rather than in the first direction, and includes a backlight which illuminates the liquid crystal display device with the illumination light. In this case, the light distribution characteristics of the video light can be adjusted to a desired state using the backlight.

In another specific aspect of the invention, the virtual image display device further includes an illumination device which includes a backlight for illuminating the liquid crystal display device with illumination light, and a light distribution control portion which is disposed between the backlight and the liquid crystal display device and controls light distribution characteristics of the illumination light emitted from the backlight to a state where a light distribution angle is large in the second direction rather than in the first direction. In this case, the light distribution characteristics of the video light can be adjusted to a desired state using the light distribution control portion.

In another specific aspect of the invention, the light distribution control portion is any of a lens, an anisotropic diffusion sheet, and a holographic diffuser. In this case, the spread of the video light can be relatively easily and securely adjusted.

In another specific aspect of the invention, the video element has a lens array on a light emission side. In this case, the video light can be emitted in a state where the light distribution characteristics of the video light are allowed to have a spread using the lens array.

In another specific aspect of the invention, in the video element, the lens array has different curvatures in a first direction corresponding to the vertical direction and in a second direction corresponding to the horizontal direction. In this case, the lens array has different curvatures, and thus the light distribution angle of the video light can be further widened in the horizontal direction.

In another specific aspect of the invention, a pair of the video elements is configured to be arranged in the horizontal direction, and enables binocular vision. In this case, one image can be visually recognized with right and left eyes. Particularly, recognizing a good image can be observed by suppressing a luminance difference between the right and left eyes.

Another aspect of the invention is directed to a virtual image display device including a video element which generates video light and a light guide member which guides the video light from the video element, in which a pair of the video elements is configured to be arranged in a horizontal direction corresponding to a lateral direction in which eyes of an observer are arranged, to allow the virtual image display device to enable binocular vision, and when a focal distance of an optical system configured to include the video element and the light guide member is represented by f and a distance from a lens principal point of the optical system to a pupil position is represented by Di, the focal distance f and the distance Di are the same or approximately the same as each other.

In the virtual image display device, image projection is performed in a telecentric or near-telecentric state in which the focal distance f and the distance Di are the same or approximately the same as each other in the optical system, and thus the occurrence of a reduction in luminance that is associated with a change of an emission angle of the video light according to an emission position from the video element can be avoided. Whereby, luminance difference between the right and left sides when binocular vision is possible can be suppressed.

In a specific aspect of the invention, in the optical system configured to include the video element and the light guide member, a maximum difference in luminance of rays of the video light is within a predetermined position in a range of an angle at which the video light is emitted in the horizontal direction. In this case, in the range of the angle at which the video light is emitted, a maximum difference in luminance of rays is adjusted to be, for example, within 30% of a maximum value of the luminance of rays. Thus, the difference can be at such a level that it can be rarely recognized during viewing, and thus a good image can be displayed.

In another specific aspect of the invention, in the optical system configured to include the video element and the light guide member, when an Eyring diameter is represented by De, an angle which is formed between a normal line of the panel and an emission direction of video light in the horizontal direction is represented by θh, regarding luminance Iθh of rays which are emitted at the angle θh, a maximum value of the luminance of rays in the range of the Eyring diameter is represented by Imaxθh, a minimum value thereof is represented by Iminθh, and a maximum telecentric angle which shows non-telecentricity and is determined based on a difference between the focal distance f and the distance Di is represented by φmax, when

$$- ( {tan}^{- 1} ( \frac{De}{2 f} ) + {φ}_{max} ) \leq {θ}_{h} \leq ( {tan}^{- 1} ( \frac{De}{2 f} ) + {φ}_{max} )$$

is satisfied,

$$\frac{( {I}_{max} {θ}_{h} - {I}_{min} {θ}_{h} )}{{I}_{max} {θ}_{h}} \leq 0.3$$

is satisfied. Here, the Eyring diameter means a lighting diameter with which a virtual image can be captured to match interpupillar distances of individuals. In this case, it is possible to avoid the occurrence of a large luminance difference resulting from light distribution characteristics, and thus, for example, a luminance difference between the right and left sides can be suppressed.

In another specific aspect of the invention, in the optical system configured to include the video element and the light guide member, the focal distance f and the distance Di are the same as each other, and thus a value of the maximum telecentric angle φmax is zero. In this case, the optical system is telecentric. Accordingly, for example, when an eye is at the center of the Eyring diameter, which is a standard position, components emitted in a direction parallel to the direction of the normal line of the video element can be captured in case of any video light emitted from any position in the video element.

In another specific aspect of the invention, in the video element for a right eye and the video element for a left eye which are configured as a pair arranged in the horizontal direction, video light having light distribution characteristics which are symmetric in the horizontal direction is emitted. In this case, video light for a right eye and video light for a left eye can be adjusted symmetrically to each other in a horizontal direction (right-left direction) which is a direction in which eyes of an observer are arranged. Accordingly, a luminance difference that is associated with a change of an emission angle according to the light distribution characteristics is matched between the right eye side and the left eye side, and thus even when the eye is positioned at a position deviating from the center of the Eyring diameter, which is a standard position, a relative luminance difference between the right and left sides can be suppressed.

In another specific aspect of the invention, the video element for a right eye and the video element for a left eye which are configured as a pair arranged in the horizontal direction are arranged centrosymmetrically in the horizontal direction. In this case, in general, since eyes of human beings are disposed approximately bilaterally symmetrically around a nose, it is possible to form an image at positions symmetric to the right and left eyes.

In another specific aspect of the invention, the light guide member is a prism-type member which guides video light and allows external light to pass therethrough to allow the video light and the external light to be visually recognized.

In another specific aspect of the invention, the light guide member allows an intermediate image to be formed therein as a part of an optical system which guides the video light. In this case, it is possible to reduce the whole optical system in size and weight and to realize the bright, high-performance display with a large angle of view.

### BRIEF DESCRIPTION OF THE DRAWINGS

The invention will be described with reference to the accompanying drawings, wherein like numbers reference like elements.

FIG. 1 is a perspective view illustrating an external appearance of a virtual image display device of a first embodiment.

FIG. 2A is a cross-sectional view of a main body portion of a first display device of the virtual image display device when viewed from above, and FIG. 2B is a front view of the main body portion.

FIG. 3A is a cross-sectional view illustrating a configuration of an image display device, and FIG. 33 is a front view showing a shape of a display pixel.

FIG. 4 is a cross-sectional view illustrating a configuration of an image display device of a modification example.

FIGS. 5A to 5C are diagrams illustrating a configuration of an image display device of another modification example.

FIG. 6A is a graph showing an example of light distribution characteristics of a video element on the right eye side, and FIG. 6B is a graph showing an example of light distribution characteristics of a video element on the left eye side.

FIG. 7 is a development view schematically showing optical systems of a virtual image display device according to a second embodiment.

FIG. 8 is a diagram showing a relationship between the optical systems of the virtual image display device and light distribution characteristics.

FIG. 9 is a diagram showing a relationship between optical systems and light distribution characteristics of a virtual image display device of a comparative example.

FIG. 10A is a diagram for illustrating telecentricity of the optical system of the virtual image display device, and FIG. 10B is a diagram of another example of the optical system of the virtual image display device.

FIG. 11 is a diagram showing a value of luminance of rays in a graph showing an example of light distribution characteristics.

### DESCRIPTION OF EXEMPLARY EMBODIMENTS

### First Embodiment

Hereinafter, a virtual image display device of a first embodiment according to the invention will be described in detail with reference to the drawings.

### A. External Appearance of Virtual Image Display Device

A virtual image display apparatus 100 according to this embodiment shown in FIG. 1 is a head-mounted display which enables binocular vision and has an external appearance like glasses. The virtual image display device 100 can allow an observer wearing the virtual image display device 100 to visually recognize image light corresponding to a virtual image and allow the observer to visually recognize or observe an external image in a see-through manner. The virtual image display device 100 includes a see-through member 101 which covers the front of eyes of the observer, a frame 102 which supports the see-through member 101, and first and second built-in device portions 105a and 105b which are installed in portions ranging from cover portions at both right and left ends of the frame 102 to rear temple portions, respectively. Here, the see-through member 101 is a curved thick optical member (transmissive eye cover) which covers the front of eyes of the observer, and is divided into a first optical portion 103a and a second optical portion 103b. A first display device 100A on the left side in the drawing, in which the first optical portion 103a and the first built-in device portion 105a are combined, is a portion which forms a virtual image for a right eye, and functions as a virtual image display device independently. In addition, a second display device 1003 on the right side in the drawing, in which the second optical portion 103b and the second built-in device portion 105b are combined, is a portion which forms a virtual image for a left eye, and functions as a virtual image display device independently.

### B. Structure of Display Device

As shown in FIGS. 2A and 23 and the like, the first display device 100A includes a projection/see-through device 70 and an image display device 80. The projection/see-through device 70 includes a light guide member 10, a light transmission member 50, and a projection lens 30 for imaging. The light guide member 10 and the light transmission member 50 are formed integrally with each other by bonding, and are firmly fixed to the lower side of a frame 61 so that for example, an upper surface 10e of the light guide member 10 and a lower surface 61e of the frame 61 are brought into contact with each other. The projection lens 30 is fixed to an end portion of the light guide member 10 via a lens tube 62 storing the projection lens 30. The light guide member 10 has a mounting portion (not shown) which is formed to enable mounting on the frame 61. In the projection/see-through device 70, the light guide member 10 and the light transmission member 50 correspond to the first optical portion 103a in FIG. 1, and the projection lens 30 of the projection/see-through device 70 and the image display device 80 correspond to the first built-in device portion 105a in FIG. 1. Since the second display device 100B shown in FIG. 1 has a similar structure to the first display device 100A, except for horizontal inversion, the detailed description of the second display device 100B will be omitted.

In the projection/see-through device 70, the light guide member 10 which is a prism-type member is an arc-like member curved along a face when viewed from above, and can be considered by division into a first prism portion 11 on the central side close to a nose and a second prism portion 12 on the peripheral side separated from the nose. The first prism portion 11 is disposed on the light emission side and has a first surface S11, a second surface S12, and a third surface S13 as side surfaces having an optical function. The second prism portion 12 is disposed on the light incidence side and has a fourth surface S14, a fifth surface S15, and a sixth surface S16 as side surfaces having an optical function. Among these, the first surface S11 is adjacent to the fourth surface S14 and the third surface S13 is adjacent to the fifth surface S15. The second surface S12 is disposed between the first surface S11 and the third surface S13 and the sixth surface S16 is disposed between the fourth surface S14 and the fifth surface S15. In addition, the light guide member 10 has a first side surface 10e and a second side surface 10f which are adjacent to the first to sixth surfaces S11 to S16 and are opposed to each other.

In the light guide member 10, the first surface S11 is a free curved surface in which an emission-side optical axis AXO parallel to the Z axis is set as a central axis or a reference axis. The second surface S12 is a free curved surface in which an optical axis AX1 which is included in a reference surface SR parallel to the X-Z surface and inclined with respect to the Z axis is set as a central axis or a reference axis. The third surface S13 is a free curved surface in which the emission-side optical axis AXO is set as a central axis or a reference axis. The fourth surface S14 is a free curved surface in which a bisector of a pair of optical axes AX3 and AX4 which is included in the reference surface SR parallel to the X-Z surface and inclined with respect to the Z axis is set as a central axis or a reference axis. The fifth surface S15 is a free curved surface in which a bisector of a pair of optical axes AX4 and AX5 which is included in the reference surface SR parallel to the X-Z surface and inclined with respect to the Z axis is set as a central axis or a reference axis. The sixth surface S16 is a free curved surface in which the optical axis AX4 which is included in the reference surface SR parallel to the X-Z surface and inclined with respect to the Z axis is set as a central axis or a reference axis. The above first to sixth surfaces S11 to S16 are shaped to be symmetrical to each other around the vertical (or longitudinal) Y-axis direction with the reference surface SR, which extends horizontally (or transversely) and is parallel to the X-Z surface and through which the optical axes AX1 to AX4 and the like pass, interposed therebetween.

The light guide member (prism) 10 is made from a resin material exhibiting high light permeability in a visible range and is molded by injecting a thermoplastic resin into a mold and solidifying the thermoplastic resin. A main body portion 10s of the light guide member 10 is an integrally molded product. However, it can be considered by division into the first prism portion 11 and the second prism portion 12. The first prism portion 11 enables guiding and emission of video light GL and transmission of external light HL. The second prism portion 12 enables incidence and guiding of the video light GL.

In the first prism portion 11, the first surface S11 functions as a refractive surface from which the video light GL is emitted to the outside of the first prism portion 11, and also functions as a total reflective surface from which the video light GL is totally reflected on the inner surface side thereof. The first surface S11 is disposed in front of an eye EY, and has a concave shape with respect to an observer. The first surface S11 may be coated on the main body portion 10s with a hard coating layer in order to prevent surface damage and image resolution reduction. The hard coating layer is formed by applying a coating agent formed of a resin or the like to a base surface of the main body portion 10s by a dipping process or a spray coating process.

The second surface S12 includes a half mirror layer 15. The half mirror layer 15 is a reflective film (that is, a semi-transmissive reflective film) having light permeability. The half mirror layer (the semi-transmissive reflective film) 15 is not formed on the overall area of the second surface S12, but is formed on a partial area PA thereof. That is, the half mirror layer 15 is formed on the partial area PA obtained by mainly narrowing an overall area QA in which the second surface S12 is enlarged in a vertical direction. More specifically, the partial area PA is disposed on the central side in the vertical Y axis direction and is disposed approximately throughout in a direction along the horizontal reference surface SR. The half mirror layer 15 is formed by forming a metal reflective film or a dielectric multilayer film on the partial area PA of the base surface of the main body portion 10s. The reflectance of the half mirror layer 15 to the video light GL is set to 10% to 50% in an expected incident angle range of the video light GL from the viewpoint of ease of observation of the external light HL in a see-through manner. According to a specific example, the reflectance of the half mirror layer 15 to the video light GL is set to 20%, for example, and the transmittance of the video light GL is set to 80%, for example.

The third surface S13 functions as a total reflective surface from which the video light GL is totally reflected on the inner surface side thereof. The third surface S13 may be coated on the main body portion 10s with a hard coating layer in order to prevent surface damage and image resolution reduction. The third surface S13 is disposed in front of the eye EY, and has a concave shape with respect to the observer similarly to the first surface S11. When the external light HL is viewed after passing through the first surface S11 and the third surface 313, the diopter is approximately 0.

In the second prism portion 12, the fourth surface 314 and the fifth surface S15 each function as a total reflective surface from which the video light GL is totally reflected on the inner surface side thereof, or are coated with a mirror layer 17 and function as a reflective surface. When the fourth surface S14 and the fifth surface 315 function as total reflective surfaces, the main body portion 10s may be coated with a hard coating layer in order to prevent surface damage and image resolution reduction.

The sixth surface 316 functions as a refractive surface which allows the video light GL to enter the second prism portion 12. The sixth surface S16 may be coated on the main body portion 10s with a hard coating layer in order to prevent surface damage and image resolution reduction, and the main body portion 10s may be coated with a multilayer film in order to suppress ghosting by reflection prevention.

The light transmission member 50 is integrally fixed to the light guide member 10. The light transmission member 50 is a member (auxiliary prism) which supports the see-through function of the light guide member (prism) 10, and has a first transmission surface S51, a second transmission surface S52, and a third transmission surface S53 as side surfaces having an optical function. Here, the second transmission surface S52 is disposed between the first transmission surface S51 and the third transmission surface S53. The first transmission surface S51 is disposed on a curved surface extending from the first surface S11 of the light guide member 10, the second transmission surface S52 is a curved surface which is bonded to the second surface S12 with an adhesive CC to be integrated therewith, and the third transmission surface S53 is disposed on a curved surface extending from the third surface S13 of the light guide member 10. Among these, the second transmission surface S52 and the second surface S12 of the light guide member 10 are formed integrally with each other by bonding, and thus the second transmission surface S52 and the second surface S12 are shaped to have approximately the same curvature.

The light transmission member (auxiliary prism) 50 is made from a resin material which exhibits high light permeability in a visible range and has approximately the same refractive index as that of the main body portion 10s of the light guide member 10. The light transmission member 50 is formed by molding of, for example, a thermoplastic resin.

The projection lens 30 is retained in the lens tube 62, and the image display device 80 is fixed to an end of the lens tube 62. The second prism portion 12 of the light guide member 10 is connected to the lens tube 62 which retains the projection lens 30 and indirectly supports the projection lens and the image display device 80. An additional light-shielding portion BP which prevents external light from entering the light guide member 10 may be provided around the light guide member 10 as shown by the broken line in FIG. 2A. The light-shielding portion BP may be configured to have, for example, a light-shielding coating or a light-scattering layer, and thus can previously remove unnecessary light components when video light enters from the projection lens 30 to the light guide member 10. The light-shielding portion BP is provided so that the passage of a light flux which is necessary light among video light is not disturbed or new unnecessary light components are not formed by unintended reflection. The position shown in the drawing, at which the light-shielding portion BP is formed, is just an example, and the light-shielding portion BP may be appropriately provided at a different position.

The projection lens 30 includes, for example, three lenses 31, 32, and 33 along an incidence-side optical axis AXI. The respective lenses 31, 32, and 33 are axisymmetric lenses, and at least one thereof has an aspheric surface. The projection lens 30 allows the video light GL emitted from the image display device 80 to enter the light guide member 10 through the sixth surface S16 of the light guide member 10 for re-imaging. That is, the projection lens 30 is a relay optical system for re-imaging the video light or the image light emitted from each point on an image surface (display position) OI of a video display element 82 in the light guide member 10. Each surface of the light guide member 10 functions as a part of the relay optical system in cooperation with the projection lens 30.

The image display device 80 has an illumination device 81 which emits two-dimensional illumination light SL, the video display element 82 which is a transmissive spatial light modulation device, and a driving control portion 84 which controls operations of the illumination device 81 and the video display element 82.

The illumination device 81 of the image display device 80 has a light source 81a which generates light including three colors of red, green, and blue, and a backlight guide portion 81b which diffuses the light from the light source 81a and converts the light into a light flux having a rectangular cross-section. The video display element 82 is a video element formed by a liquid crystal display device, for example, and spatially modulates the illumination light SL from the illumination device 81 to form image light which is an object to be displayed, such as a moving picture. The driving control unit 84 includes a light source driving circuit 84a and a liquid crystal driving circuit 84b. The light source driving circuit 84a supplies electric power to the light source 81a of the illumination device 81 and emits the illumination light SL with stable luminance. The liquid crystal driving circuit 84b outputs an image signal or a driving signal to the video display element (video element) 82 to form color image light which is a basis of a moving picture or a still image as a transmittance pattern. In addition, the liquid crystal driving circuit 84b may be provided with an image processing function, but the image processing function may be provided in a control circuit which is externally attached. Although will be described later in detail, in this embodiment, in the image display device 80, video light is controlled so that a light distribution angle is large in a horizontal direction (the X direction in the drawing) which is a lateral direction in which the eyes EY of the observer are arranged, rather than in a vertical direction (the Y direction in the drawing) which is a longitudinal direction perpendicular to the lateral direction.

### C. Optical Path of Video Light or the Like

Hereinafter, an optical path of the video light GL or the like in the virtual image display apparatus 100 will be described.

The video light GL emitted from the video display element (video element) 82 enters the sixth surface S16 having relatively strong positive refractive power provided in the light guide member 10 while being converged by the projection lens 30.

The video light GL passing through the sixth surface S16 of the light guide member 10 advances while being converged. When passing through the second prism portion 12, the video light GL is reflected on the fifth surface S15 having relatively weak positive refractive power, and is reflected on the fourth surface 914 having relatively weak negative refractive power.

The video light GL reflected on the fourth surface 914 of the second prism portion 12 enters the third surface S13 having relatively weak positive refractive power to be totally reflected thereon in the first prism portion 11, and enters the first surface S11 having relatively weak negative refractive power to be totally reflected thereon. The video light GL forms an intermediate image in the light guide member 10 before and after passing through the third surface S13. An image surface II of the intermediate image corresponds to the image surface (display position) OI of the video display element 82, but is turned back on the third surface S13.

The video light GL which is totally reflected on the first surface S11 enters the second surface S12, but particularly, the video light GL entering the half mirror layer 15 is partially reflected while partially passing through the half mirror layer 15, and enters again the first surface S11 to pass therethrough. The half mirror layer 15 has relatively strong positive refractive power with respect to the reflected video light GL. The first surface S11 has negative refractive power with respect to the video light GL passing therethrough.

The video light GL passing through the first surface S11 enters a pupil of the eye EY of the observer as an approximately parallel light flux. That is, the observer observes the image formed on the video display element 82 by the video light GL as a virtual image.

External light HL entering a side in the +X direction rather than the second surface S12 of the light guide member 10 passes through the third surface S13 and the first surface S11 of the first prism portion 11. At this time, positive and negative refractive powers cancel out, and aberration is corrected. That is, the observer observes an external image having less distortion through the light guide member 10. Similarly, when external light HL entering a side in the −X direction rather than the second surface S12 of the light guide member 10, that is, light entering the light transmission member 50 passes through the third transmission surface S53 and the first transmission surface S51 provided therewith, positive and negative refractive powers cancel out, and aberration is corrected. That is, the observer observes an external image having less distortion through the light transmission member 50. Furthermore, when external light HL entering the light transmission member 50 corresponding to the second surface S12 of the light guide member 10 passes through the third transmission surface S53 and the first surface S11, positive and negative refractive powers cancel out, and aberration is corrected. That is, the observer observes an external image having less distortion through the light transmission member 50. The second surface S12 of the light guide member 10 and the second transmission surface S52 of the light transmission member 50 have approximately the same curved surface shapes and have approximately the same refractive indexes, and a gap therebetween is filled with the adhesive layer CC having approximately the same refractive index. That is, the second surface S12 of the light guide member 10 or the second transmission surface S52 of the light transmission member 50 does not act as refractive surfaces with respect to the external light HL.

However, since the external light HL entering the half mirror layer 15 is partially reflected while partially passing through the half mirror layer 15, the external light HL in a direction corresponding to the half mirror layer 15 is weakened due to the transmittance of the half mirror layer 15. On the other hand, since video light GL enters in the direction corresponding to the half mirror layer 15, the observer observes the image formed on the video display element 82 in the direction of the half mirror layer 15 and the external image.

Among the video light GL which is propagated in the light guide member 10 and enters the second surface S12, light which is not reflected on the half mirror layer 15 enters the light transmission member 50. However, the light is prevented from being returned to the light guide member 10 by an antireflection portion (not shown) provided in the light transmission member 50. That is, the video light GL passing through the second surface S12 is prevented from being returned onto the optical path and being thus stray light. In addition, the external light HL which enters from the side of the light transmission member 50 and is reflected on the half mirror layer 15 is returned to the light transmission member 50, and is prevented from being emitted to the light guide member 10 by the antireflection portion (not shown) provided in the light transmission member 50. That is, the external light HL which is reflected on the half mirror layer 15 is prevented from being returned onto the optical path and being thus stray light.

In the above-described virtual image display device 100, in order to visually recognize a good image, it is important to secure a certain degree or higher than the certain degree of luminance particularly in a horizontal direction (the X direction in the drawing) which is a lateral direction in which the eyes EY are arranged within a specific angle range. This is because the lateral direction is a direction in which the eyes are moved more often than in a longitudinal direction (the Y direction in the drawing) perpendicular to the lateral direction, and when binocular vision is possible, there are differences in individuals in the interpupillar distance in the lateral direction, and thus some margin is required. Here, the video light emitted from the image display device 80 has light distribution characteristics. The light distribution characteristics are determined based on, for example, the configurations of the illumination device 81 functioning as a backlight and the video display element 82. That is, the light distribution characteristics are determined based on the configuration of the image display device 80. However, it is also necessary to reduce the size of the video display element 82 configured to have a liquid crystal panel or the like, and therefore to reduce the size of the image display device 80 when reducing the virtual image display device 100 in size, and the smaller the display pixels of the video display element 82, the narrower the angle range in which the luminance is maintained in or higher than a specific range. That is, the light distribution angle is easily narrowed and the luminance of the video light is thus difficult to secure.

However, in this embodiment, in the image display device 80 including the video display element 82, the light distribution characteristics of the video light are controlled to a state where the light distribution angle is large in the horizontal direction (X direction) corresponding to the lateral direction, rather than in the vertical direction (Y direction) corresponding to the longitudinal direction perpendicular to the lateral direction in which the eyes EY of the observer are arranged, and then emission is carried out. Accordingly, a luminance difference which occurs by an emission angle related to the horizontal direction of the video light is suppressed. Here, particularly, in the video display element (video element) 82 which is a liquid crystal display device, display pixels of the video display element 82 have an opening-shaped portion which is wide in the horizontal direction rather than in the vertical direction, and thus the light distribution characteristics of the video light is controlled to a state where the light distribution angle is large in the horizontal direction.

Hereinafter, a configuration of the video display element 82 and the like in the image display device 80 will be described with reference to FIG. 3A and the like. FIG. 3A is a cross-sectional view for illustrating configurations of the illumination device 81 and the video display element 82 of the image display device 80. FIG. 3B is a front view showing a shape of one display pixel EE in the video display element 82.

As described above, the image display device 80 has the illumination device 81 which emits illumination light SL and the video display element 82, and the illumination device 81 has the light source 81a which generates light including three colors of red, green, and blue and the backlight guide portion 81b which diffuses the light from the light source 81a and converts the light into a light flux having a rectangular cross-section.

The video display element 82 includes a liquid crystal layer 71, and a thin film transistor (TFT) layer 72 on the incidence side and an electrode layer 73 on the emission side with the liquid crystal layer 71 interposed therebetween. A color filter layer 74 is also included on the emission side of the electrode layer 73. Although omitted in the drawing, the video display element 82 includes a first substrate which is disposed closer to the incidence side than the TFT layer 72 and a second substrate on the emission side which is disposed closer to the emission side than the color filter layer 74. In addition, if necessary, a polarizing plate is formed.

In the video display element 82, the TFT layer 72 has a plurality of transparent pixel electrodes 75 disposed in matrix, a thin film transistor (not shown) electrically connected to each transparent pixel electrode 75, and a light distribution film 76. In addition, the TFT layer 72 includes a black matrix BM for partitioning into the plurality of transparent pixel electrodes 75 and for shielding unnecessary light toward the thin film transistor ahead. The electrode layer 73 has a transparent pixel electrode 77 (common electrode) and a light distribution film 78. That is, in the video display element 82, the liquid crystal layer 71, and the TFT layer 72 and the electrode layer 73 with the liquid crystal layer 71 interposed therebetween correspond to a portion which functions as a liquid crystal display device for modulating a polarization state of incident light in accordance with an input signal as an optical active element.

In addition, the color filter layer 74 includes color filter portions RF, GF, and BF for respective colors of red (R), green (G), and blue (B). A shade layer 79 is used for partitioning into the color filter portions RF, GF, and BF. In FIG. 3A, only one set of color filter portions RF, GF, and BF is shown, but such color filter portions RF, GF, and BF form the display pixel EE shown in FIG. 33. This is set as one unit and a large number of units are disposed in matrix. That is, the video display element 82 is a color filter type. More specifically, the color filter portions RF, GF, and BF partitioned by the shade layer 79 as shown in FIG. 3A are sub-pixels RP, GP, and BP of respective colors having three horizontally long opening-shaped portions OP as shown in FIG. 3B, and the sub pixels RP, GP, and BP constitute one square pixel, that is, a display pixel EE. The shade layer 79 avoids color mixing of the sub-pixels RP, GP, and BP between the sub-pixels RP, GP, and BP.

In the above, the color filter layer 74 includes the shade layer 79, and thus when illumination light SL passes through the color filter portions RF, GF, and BF, it does not enter an unintended portion. However, the shade layer 79 also restricts a range in which the light can be captured in the color filter portions RF, GF, and BF. For example, components (components which can pass through the sub-pixels GP) which are captured as green light among the illumination light SL in the drawing correspond to a range indicated by the arrow. Even when the sub-pixels RP, GP, and BP are reduced in size, in order to allow the shade layer 79 to function to prevent color mixing, it is necessary to secure a minimum width. That is, as the smaller the video display element 82, the greater the relative ratio of the shade layer 79 to the color filter layer 74. That is, the smaller the video display element 82, the narrower the light distribution angle.

Regarding this, in this embodiment, the sub-pixels RP, GP, and BP having the horizontally long opening-shaped portions OP are disposed to secure the state where the light distribution angle is wide in the horizontal direction. Specifically, first, in the arrangement of the sub-pixels RP, GP, and BP shown in FIG. 3B, they direction (first direction) is a direction corresponding to the Y direction of FIG. 2A, that is, a direction corresponding to the longitudinal direction perpendicular to the direction in which the eyes EY of the observer are arranged, and the x direction (second direction) in the drawing is a direction corresponding to the X direction of FIG. 2A, that is, a direction corresponding to the X direction parallel to the direction in which the eyes EY of the observer are arranged. As shown in the drawing, the three sub-pixels RP, GP, and BP have the same opening-shaped portions OP which are large in the second direction (x direction) which is a lateral direction corresponding to the horizontal direction rather than in the first direction (y direction) which is a longitudinal direction corresponding to the vertical direction. Furthermore, the three horizontally long sub-pixels RP, GP, and BP are aligned to be arranged into a border in the first direction (y direction) which is a longitudinal direction, and constitute a display pixel EE which is a square pixel.

As an example of more specific dimensions of the sub-pixels RP, GP, and BP, a width Wy in the longitudinal direction (y direction) is 1.7 μm, and a width Wx in the lateral direction (x direction) is 7.0 μm. In addition, one pixel, i.e., one display pixel EE is a square pixel, on a side of which has a length L of 9.6 μm. In this case, in the longitudinal direction (vertical direction), the respective sub-pixels RP, GP, and BP have a small opening width, and thus the light distribution angle is narrowed. In the lateral direction (horizontal direction), a large opening width can be secured in the respective sub-pixels RP, GP, and BF, and the light distribution angle can be widened.

As described above, in this embodiment, the sub-pixels RP, GP, and BP of the display pixel EE have opening-shaped portions which are wide in the second direction corresponding to the horizontal direction corresponding to the lateral direction parallel to the direction in which the eyes of the observer are arranged, rather than in the first direction corresponding to the vertical direction corresponding to the longitudinal direction perpendicular to the direction in which the eyes of the observer are arranged. Thus, the light distribution angle is controlled to be wide in the horizontal direction and a luminance difference which occurs by an emission angle related to the horizontal direction of the video light is suppressed. That is, it is possible to observe a good image in which the luminance of video light is adjusted and to reduce fatigue in the observer. In this case, particularly, in the virtual image display device 100 having a pair configuration which enables binocular vision, since the luminance difference between the right and left sides can be suppressed, it is possible to avoid making the observer feel uncomfortable or feel fatigued easily due to a luminance difference between the right eye side and the left eye side. In addition, in the above description, the three sub-pixels RP, GP, and BP of red (R), green (G), and blue (B) constitute one pixel. However, for example, four or more sub-pixels including a white (W) or yellow (Y) pixel in addition to the three pixels may constitute one pixel.

In the luminance device 81, by adjusting a light diffusion direction in the backlight guide portion 81b of the backlight, the light distribution characteristics can also be controlled to a state where the light distribution angle is large in the second direction (lateral direction) rather than in the first direction (longitudinal direction). A desired light distribution angle can be provided using, for example, a diffusion film in which anisotropy is imparted to a backlight portion or two prism sheets in which different characteristics are imparted in directions corresponding to the first direction and the second direction.

FIG. 4 is a cross-sectional view for illustrating a configuration of an image display device 80 of a modification example of this embodiment. Specifically, in this modification example, an illumination device 81 of the image display device 80 has, in addition to a light source and a backlight guide portion 81b of a backlight for illumination onto a video display element 82 which is a liquid crystal display device, a light distribution control portion 81c which controls light distribution characteristics of illumination light to a state where the light distribution angle is large in a second direction (lateral direction) rather than in a first direction (longitudinal direction). The light distribution control portion 81c is disposed between the backlight guide portion 81b and the video display element 82. The light distribution control portion 81c controls light distribution characteristics of illumination light SL emitted from the backlight guide portion 81b to a state where the light distribution angle is large in the second direction (lateral direction) rather than in the first direction (longitudinal direction). The light distribution control portion 81c is configured to have, for example, any of a lens, an anisotropic diffusion sheet, and a holographic diffuser, and thus the illumination light SL can be controlled to have light distribution characteristics having a desired spread.

FIGS. 5A, 5B, and 5C are diagrams illustrating a configuration of an image display device 80 of another modification example of this embodiment. Specifically, as shown in FIG. 5A, in this modification example, a video display element 82 has a lens array ML on the light emission side. Specifically, the lens array ML is configured to have a plurality of lens elements MLa, and the plurality of lens elements MLa correspond to arrays of color filter portions RF, GF, and BF of respective colors. That is, one color filter portion (sub-pixel) corresponds to one lens element MLa. In addition, as shown in FIGS. 5B and 5C, the respective lens elements MLa of the lens array ML have different curvatures in a first direction (y direction) corresponding to a vertical direction and in a second direction (x direction) corresponding to a horizontal direction. In this case, the curvature is adjusted so that regarding the light emitted from the lens element MLa, video light GL spreads at a desired angle in the second direction (x direction) corresponding to the horizontal direction, and thus luminance in the horizontal direction can be secured.

In this embodiment, the virtual image display device 100 including a pair of display devices 100A and 100B has been described, but a single display device may be used. That is, a configuration may be employed in which the projection/see-through device 70 and the image display device 80 are not provided as a set corresponding to both of the right eye and the left eye, and the projection/see-through device 70 and the image display device 80 are provided with respect to only one of the right eye and the left eye to view the image with a single eye.

### Second Embodiment

Hereinafter, a virtual image display device according to a second embodiment will be described. Since the virtual image display device according to this embodiment is a modification example of the virtual image display device 100 according to the first embodiment, the description of the entire device and the respective portions thereof will be omitted.

The graphs of FIGS. 6A and 6B are graphs showing an example of light distribution characteristics of video light which is emitted from a video display element of the virtual image display device according to this embodiment. More specifically, the virtual image display device according to this embodiment has a pair configuration having a video display element (video element) for a right eye and a video display element (video element) for a left eye, FIG. 6A shows an example of light distribution characteristics on the right eye side, and FIG. 6B shows an example of light distribution characteristics on the left eye side. In the graphs shown in FIGS. 6A and 6B, the horizontal axis represents an emission angle of the video light in a horizontal direction corresponding to a lateral direction parallel to a direction in which eyes of an observer are arranged. That is, the horizontal axis represents an angle with respect to a normal line of the video display element. The vertical axis represents luminance of video light (luminance of rays). As is obvious from the graphs, in the video display element of this embodiment, the light distribution characteristics are slightly inclined with respect to a direction of the normal line of the video display element, and the peak slightly deviates from the center. In addition, the larger the angle with respect to the position of the peak, the lower the luminance of the video light. As exemplified in FIGS. 6A and 6B, when the light distribution characteristics are provided so that the position of the peak is out of the direction of the normal line of the video display element and deviates from the peak of the light distribution characteristics, and thus the luminance is relatively rapidly reduced, a large luminance difference easily occurs between the right eye side and the left eye side. When the luminance difference is large, the observer feels uncomfortable or feels fatigued easily. In this embodiment, the luminance difference between the right side and the left side resulting from the light distribution characteristics is suppressed. Therefore, although will be described later in detail, regarding the degree of the inclination with respect to the direction of the normal line of the video display element, bilaterally symmetrical light distribution characteristics are provided so that there is positive/negative inversion of the inclination on the right eye side and the left eye side, as shown by the angles α in FIGS. 6A and 6B.

FIG. 7 is a development view schematically showing optical systems of the virtual image display device 100 in a simplified manner. Here, an optical system 1008 represents an optical system on the right eye side, and an optical system 100L represents an optical system on the left eye side. The optical systems 100R and 100L are represented by virtual convex lenses RL and LL, and the optical axes AXI and AXO and the like shown in FIG. 2A are represented by an optical axis AX. As shown in the drawing, the virtual image display device 100 has a pair of right and left image display devices 80R and 80L to allow an image to be visually recognized by allowing video light from a video display element 82R for a right eye of the image display device 80R for a right eye and a video display element 82L for a left eye of the image display device 80L for a left eye to reach a right eye R and a left eye L, respectively. In addition, as shown in the drawing, H represents an interpupillar distance which is a distance between the right eye R and the left eye L which are eyes EY of the observer. In the drawing, the right eye R (EY) and the left eye L (EY) are drawn to be positioned out of the optical path for the sake of easy understanding, but when the virtual image display device 100 is mounted, the right eye R and the left eye L are disposed at pupil positions PPR and PPL or therearound, respectively.

Here, in the pupil positions PPR and PPL, a lighting diameter with which a virtual image can be captured to match interpupillar distances H of individuals is represented by an Eyring diameter De. That is, when each of the right and left eyes R and L is present within the Eyring diameter De, the video can be viewed with both eyes. A sufficiently large Eyring diameter De is employed to allow the observation of a virtual image by the virtual image display device 100 without adjustment of the interpupillar distance H, which varies from person to person, on the device side. In addition, in the optical systems 100R and IDOL, f represents focal distances which are distances from lens principal points LP to light emission positions DPR and DPL of the video display elements 82R and 82L. Di represents distances from the lens principal points LP of the optical systems 100R and 100L to the pupil positions PPR and PPL. Although will be described later in detail, here, the focal distance f and the distance Di are the Same or approximately the same as each other. That is, the optical systems 100R and 100L are telecentric optical systems.

Hereinafter, an optical path of the virtual image display device 100 will be described. An optical path of the optical system 100R on the right eye side will be described, but the detailed description of an optical path of the optical system 100L on the left eye side will be omitted because of the symmetry of the right and left optical systems.

First, among video light components which are emitted from the light emission positions DPR of the video display element 82R for a right eye, components (shown by the solid line in the drawing) which are emitted from the central side, i.e., a position CE on the optical axis AX are represented by light fluxes C1, and components (shown by the broken line in the drawing) which are emitted from the peripheral side, i.e., a position PE separated from the optical axis AX are represented by light fluxes C2. The light fluxes C1 and C2 reach the eye R to overlap each other in the pupil position PPR through the convex lens RL, while having a certain degree of spread. The Eyring diameter De is determined based on a range in which the light fluxes overlap in the pupil position PPR.

Here, in the pupil position PPR, when the eye R is positioned in a standard position, that is, in a position A which is at the center of the Eyring diameter De, in any of the cases of the light fluxes C1 and C2 from the video display element 82R, components emitted in a direction n (the −z direction in the drawing) of a normal line of the panel which is perpendicular to the surface of the video display element 82R reach, because the optical system 1008 is a telecentric optical system. However, since the interpupillar distances H of human beings vary from person to person, the position of the eye R is not limited to the position A. For example, in the pupil position PPR, when the eye R is positioned in a limit position at which a virtual image can be recognized by the eye R, that is, in a position B which is at an end of the Eyring diameter De, components in a direction which forms an angle θhmax with the direction n of the normal line of the panel as shown in the drawing reach the eye R. At this time, the angle θhmax is expressed as follows, using the focal distance f of the optical system 100R and the Eyring diameter De: θhmax=tan⁻¹ (De/2f).

However, as shown in FIG. 6A, regarding the video light which is emitted from the video display element 82R, there are inclined light distribution characteristics and the luminance of rays varies with the angle, whereby an angle is formed in the direction of the normal line of the panel, and thus the luminance of rays is reduced. It can be said that the reduction in the luminance of rays also occurs in a similar manner on the left eye side, the description of the optical path of which is omitted here. The degree of the reduction in the luminance of rays and the like may be influenced by a luminance difference between the right and left sides. As described above, if there is a difference in video luminance between right and left eyes, a problem occurs in that a person feels fatigued easily while viewing a video.

Here, the positional relationship between the right and left eyes will be considered. In general, eyes EY (R and L) of human beings are positioned approximately bilaterally symmetrically around a nose NS. Accordingly, as shown in the drawing, in the case in which the virtual image display device has an axisymmetric configuration with respect to a central axis XX passing through the nose NS in a right-left direction (lateral direction), that is, a horizontal direction, when the right eye R is positioned in the position A on the central side by the size of the interpupillar distance H, the left eye L is thought to be also positioned approximately in the position A on the central side, and when the right eye R is positioned in the position B on the peripheral side, the left eye L is thought to be also positioned approximately in the position B on the peripheral side. For example, when the left eye L is positioned in the position B on the peripheral side, an angle θhmax at which a light flux enters is expressed as follows as in the case of the right eye side, using the focal distance f of the optical system 100R and the Eyring diameter De: θhmax=tan⁻¹(De/2f). However, as is obvious from the drawing, the angle θhmax on the left eye side is opposite in direction (positive and negative angles) to that of the case of the right eye side. Accordingly, there may be a large difference in luminance between the right eye side and the left eye side based on the light distribution characteristics of the image display devices 80R and 80L.

In this embodiment, as shown in FIGS. 6A and 6B, the video display elements 82R and 82L are disposed (that is, the image display devices 80R and SOL are disposed) so that the light distribution characteristics are inclined centrosymmetrically (axisymmetrically with respect to the central axis XX of FIG. 7) in a left-and-right reversed manner on the right eye (R) side and the left eye (L) side, and thus the occurrence of a luminance difference between the right and left sides is suppressed.

FIG. 8 is a diagram showing a relationship between the optical systems of the virtual image display device 100 and the light distribution characteristics. Specifically, as shown in the partial enlarged view, a curve DDR showing light distribution characteristics of the image display device 80R (the video display element 82R) in the optical system 100R on the right eye side has an orientation distribution in which a peak axis PXR is inclined so that a peak PK is provided in a direction slightly inclined to the outside (−X side) with respect to the direction n of the normal line of the panel. A curve DDL showing light distribution characteristics of the image display device 80L (the video display element 82L) in the optical system 100L on the left eye side has an orientation distribution in which a peak axis PXL is inclined so that a peak PK is provided in a direction inclined in an opposite manner (+X side) to that of the case of the right eye side with respect to the direction n of the normal line of the panel. As a result, the light distribution characteristics are provided to have a peak, that is, the maximum value of the luminance of rays, in a direction inclined by the angle α shown in FIGS. 6A and 6B, and to have a peak in a direction axisymmetric with respect to the central axis XX because of the matched-pair configuration. In this case, the luminance is reduced on the right and left sides based on an interpupillar distance H, that is, the positions of the eyes R and L in an Eyring diameter De, but since the degrees of the reduction on the right and left sides are matched, a luminance difference rarely occurs between the right eye side and the left eye side.

Regarding this, for example, in the case in which peaks PK are provided to be inclined in the same direction on the right eye side and the left eye side as in a comparative example shown in FIG. 9, when the eyes R and L are present in the position A on the central side, components enter both of the eyes R and L at an angle deviated by approximately the same angle (by the angle α) with respect to the peak PK, and thus it is considered that there is no large difference in luminance. However, when the eyes R and L are present in the position B on the peripheral side, components which are shown by the broken line CR in the partial enlarged view and are emitted at an angle approximately close to the peak PK enter the right eye R, and components which are shown by the broken line CL in the partial enlarged view and are emitted at an angle inclined about twice of the angle θhmax from the peak PK enter the left eye L. Accordingly, the luminance is high on the right eye (R) side, but is low on the left eye (L) side. That is, a bright video is seen on the right eye (R) side, but a dark video is seen on the left eye (L) side. In this embodiment, as described above, the video display elements 82R and 82L are disposed so that video light having light distribution characteristics which are centrosymmetric (axisymmetric with respect to the central axis XX) on the right eye side and the left eye side is emitted, and thus a good image in which the luminance difference is suppressed can be provided. In addition, in this embodiment, the Eyring diameter is sufficiently large. Thus, when using the device, troublesomeness in mounting is reduced without the need for individual adjustment of an interpupillar distance which varies individually. As another way of thinking, adjusting the positions of the right and left eyes to correspond to different interpupillar distances may be performed to reduce the Eyring diameter. However, when a mechanism capable of adjusting the interpupillar distance in the right-left direction is provided, problems such as an increase in weight and an increase in size may occur. Particularly, interpupillar distance adjustment needed for each user is very troublesome in use. In this embodiment, interpupillar distance adjustment is not needed, and thus the virtual image display device which is required to be reduced in size and to have an excellent design can match everyone without installation of an adjustment mechanism as much as possible.

Hereinafter, telecentricity of the optical systems 100R and 100L will be described with reference to FIGS. 10A and 10B. FIG. 10A is an example of a telecentric optical system, and FIG. 10B is an example of an optical system which slightly deviates from the telecentric state.

FIG. 10A shows an example in which image projection is performed in a telecentric or near-telecentric optical system in which the focal distance f and the distance Di shown in FIG. 7 and the like are the same or approximately the same as each other. In this case, as described above, for example, when the eye EY is positioned in the position A, components emitted parallel to the direction of the normal line of the panel are observed. That is, in any of the cases of the light fluxes C1 and C2 from the video display element 82, components emitted in a direction perpendicular to the surface of the video display element 82 reach. In addition, even when the eye EY is positioned in a position (for example, the B position) other than the position A, in any of the cases of the light fluxes C1 and C2, components emitted at an angle inclined by the same angle with respect to the direction n of the normal line of the panel reach. Accordingly, for example, symmetric light distribution characteristics are provided as shown in FIG. 8, and thus a luminance difference between the right and left sides can be reduced.

In another example shown in FIG. 10B, the focal distance f and the distance Di are slightly different from each other, and there is a slight deviation from the telecentric state. Here, an example for a case of f>D is shown. In this case, as shown in the drawing, even when the eye EY is positioned in the standard position A, no every component emitted in a direction perpendicular to the surface of the video display element 82 is observed in the cases of all light fluxes. Specifically, as shown in the drawing, regarding components emitted from the position CE on the central side of the video display element 82, components emitted parallel to the direction n of the normal line of the panel enter, but regarding components emitted from the position PE on the peripheral side of the video display element 82, components emitted at a small angle with respect to the direction n of the normal line of the panel enter. This is due to the angle resulting from the difference between the focal distance f and the distance Di, and here, the angle is referred to as a telecentric angle φ. Among telecentric angles φ, the maximum angle is referred to as a maximum telecentric angle φmax. When the maximum telecentric angle φmax is large, that is, when a non-telecentric state in which the focal distance f and the distance Di are different from each other is provided, the emission angle of the video light is changed due to a difference between the emission positions from the video display element 82 (for example, a difference between the positions CE and PE). Therefore, luminance unevenness occurs on the central side and the peripheral side of the image, and thus luminance unevenness occurs also on the left eye side and the right eye side.

Here, the luminance difference between the right and left eyes is related to a virtual image display device which is not in a see-through mode, that is, which does not allow external light to be visually recognized. From the viewpoint of the possibility of asthenopia, however, it is desirable to maintain the luminance of rays to 90% or greater of the maximum value, that is, to maintain the luminance difference to within 10%. However, it is confirmed that when 70% or greater of the luminance is secured, that is, when the luminance difference is within 30%, the difference is at such a level that it can be rarely recognized during viewing. Accordingly, it is thought that when the luminance variation level is not greater than 30%, a good image can be displayed even when how much the eyes are moved within the range of the eye relief or Eyring diameter.

Accordingly, it is thought that even when there is a slight deviation from the telecentric state as in FIG. 10B, the display of a good image can be maintained by adjusting the luminance difference to 30% or less, including the influence of the maximum telecentric angle φmax.

Hereinafter, satisfying the above requirement will be expressed by a numerical expression. First, the angle which is formed between the direction n of the normal line of the panel and the emission direction of the video light related to the horizontal direction is represented by θh. Regarding luminance Iθh of rays which are emitted at the angle θh, as shown in the graph of FIG. 11, a maximum value of the luminance of rays in the range of the Eyring diameter De is represented by Imaxθh, and a minimum value thereof is represented by Iminθh. The angle θh is determined based on the position of the eye EY, and in a telecentric state (φmax=0°), θh is 0° when the central position of the standard Eyring diameter De is the position A, and θh is θhmax (see FIG. 7 and the like) when the central position is the position B. When the angle Oh and the luminance Iθh of rays have a relationship with the maximum telecentric angle φmax as follows:

$$- ( {tan}^{- 1} ( \frac{De}{2 f} ) + {φ}_{max} ) \leq {θ}_{h} \leq ( {tan}^{- 1} ( \frac{De}{2 f} ) + {φ}_{max} ) , \qquad ( 1 )$$

the above requirement is satisfied when satisfying:

$$\frac{( {I}_{max} {θ}_{h} - {I}_{min} {θ}_{h} )}{{I}_{max} {θ}_{h}} \leq 0.3 . \qquad ( 2 )$$

That is, the expression (1) shows that the angle range of the angle θh at which the video light is emitted includes the maximum telecentric angle φmax, and when the expression (2) is satisfied in this range of the angle θh, the maximum difference in luminance in the video display elements or the right and left video display elements having a pair configuration is suppressed to within 30%. When the value of the maximum telecentric angle φmax is zero, the focal distance f and the distance Di are the same as each other in the optical system, and thus the expressions become conditional expressions for the case in which the optical system is telecentric.

As described above, in this embodiment, since the image projection is performed in a telecentric or near-telecentric state, the occurrence of a reduction in luminance that is associated with a change of the emission angle of the video light according to an emission position from the video element can be avoided. Particularly, in this embodiment, in the right and left video elements having a pair configuration, the light distribution characteristics are symmetric in the horizontal direction. Therefore, a luminance difference between the right and left sides when binocular vision is possible can be suppressed.

In this embodiment, the image display device 80 shown in the first embodiment is employed, and thus the light distribution characteristics are controlled so that the light distribution angle is wider in the horizontal direction, and the luminance in the horizontal direction can thus be further secured.

### Others

The invention has been described based on the respective embodiment, but is not limited to the above-described embodiments, and may be realized in various forms in a range without departing from the scope of the invention. For example, the following modifications may be employed.

In the above, the see-through-type virtual image display device has been described, but the invention may also be applied to a virtual image display device which is not in a see-through mode, that is, which does not allow external light to be visually recognized. As described above, since it is desirable to maintain the luminance to 90% or greater of the maximum value, that is, to maintain the luminance difference to less than 10%, it is desirable that the value on the right side is 0.1 in the expression (2) in the case of the second embodiment.

In the above description, the half mirror layer (semi-transmissive reflective film) 15 is formed in the horizontally long rectangular area, but a contour of the half mirror layer 15 may be appropriately changed according to other uses. Further, the transmittance or reflectance of the half mirror layer 15 may also be changed according to other uses.

In the above description, distribution of display luminance in the video display element 82 is not particularly adjusted, but in a case in which a luminance difference occurs according to positions, for example, it is possible to unevenly adjust the distribution of display luminance.

In the above description, the video display element 82 including a transmissive liquid crystal display device or the like is used as the image display device 80. However, the image display device 80 is not limited to the video display device 82 including a transmissive liquid crystal display device or the like, and various devices can be used. For example, it is possible to use a configuration using a reflective liquid crystal display device and to use a digital micro-mirror device or the like instead of the video display element 82 including the liquid crystal display device or the like. Furthermore, it is also possible to use a light emitting element represented by an LED array, an OLED (organic EL) or the like, as the image display device 80. When using a light emitting element, for example, in the case of the first embodiment, light emitters having a horizontally long shape are arranged into a border to constitute pixels, thereby achieving the configuration as shown in FIG. 4.

In the above embodiments, the image display device 80 including the transmissive liquid crystal display device or the like is used, but instead, a scanning image display device can also be used.

In the above description, the half mirror layer 15 is a simple semitransparent film (for example, metal reflective film or dielectric multilayer film), but the half mirror layer 15 can be replaced by a flat or curved hologram element.

In the above description, the virtual image display device 100 has been specifically as a head-mounted display, but the virtual image display device 100 may be modified into a head-up display.

In the above description, the video light is totally reflected by an interface with air without providing a mirror, a half mirror or the like on the surfaces of the first surface S11 and the third surface S13 of the light guide member 10, but the total reflection in the virtual image display device 100 according to the invention includes reflection occurring by a mirror coating or a half mirror film formed on the whole or a part of the first surface S11 or the third surface S13. For example, a case in which in a state in which the incident angle of image light satisfies the total reflection condition, mirror coating or the like is performed on the whole or a part of the first surface S11 or the third surface S13 to reflect substantially the entire image light is also included. In addition, the whole or a part of the first surface S11 or the third surface S13 may be coated with a mirror having slight permeability if it can obtain sufficiently bright image light.

In the above description, the light guide member 10 or the like extends in the horizontal direction where the eyes EY are arranged, but the light guide member 10 may be disposed to extend in the vertical direction. In this case, the optical member 110 has a structure of being arranged in parallel, not in series.

The entire disclosure of Japanese Patent Application No. 2013-048837, filed Mar. 12, 2013 is expressly incorporated by reference herein.

What is claimed is:

1. A virtual image display device comprising:
a video element which generates video light; and
a light guide member which guides the video light from the video element,
wherein the video element emits the video light after controlling light distribution characteristics thereof to a state where a light distribution angle is large, rather than in a vertical direction corresponding to a longitudinal direction perpendicular to a lateral direction in which eyes of an observer are arranged, in the horizontal direction corresponding to the lateral direction.

2. The virtual image display device according to claim 1,
wherein a pixel of the video element is shaped to be large in a second direction corresponding to the horizontal direction rather than in a first direction corresponding to the vertical direction.

3. The virtual image display device according to claim 2,
wherein the video element is a liquid crystal display device which forms video light by spatially modulating illumination light, and
wherein display pixels of the liquid crystal display device have an opening-shaped portion which is wide in the second direction rather than in the first direction.

4. The virtual image display device according to claim 3,
wherein in the liquid crystal display device, the display pixel constitutes a color filter-type pixel including at least three sub-pixels of R, B, and B, and the three sub-pixels have an opening-shaped portion which is wide in the second direction rather than in the first direction, and are arranged in the first direction.

5. The virtual image display device according to claim 3, further comprising:
an illumination device which generates illumination light having light distribution characteristics in which a light distribution angle is large in the second direction rather than in the first direction, and includes a backlight which illuminates the liquid crystal display device with the illumination light.

6. The virtual image display device according to claim 3, further comprising:
an illumination device which includes a backlight for illuminating the liquid crystal display device with illumination light, and a light distribution control portion which is disposed between the backlight and the liquid crystal display device and controls light distribution characteristics of the illumination light emitted from the backlight to a state where a light distribution angle is large in the second direction rather than in the first direction.

7. The virtual image display device according to claim 6,
wherein the light distribution control portion is any of a lens, an anisotropic diffusion sheet, and a holographic diffuser.

8. The virtual image display device according to claim 1,
wherein the video element has a lens array on a light emission side.

9. The virtual image display device according to claim 8,
wherein in the video element, the lens array has different curvatures in a first direction corresponding to the vertical direction and in a second direction corresponding to the horizontal direction.

10. The virtual image display device according to claim 1,
wherein a pair of the video elements is configured to be arranged in the horizontal direction, and enables binocular vision.

11. A virtual image display device comprising:
a video element which generates video light; and
a light guide member which guides the video light from the video element,
wherein a pair of the video elements is configured to be arranged in a horizontal direction corresponding to a lateral direction in which eyes of an observer are arranged, to allow the virtual image display device to enable binocular vision, and
wherein when a focal distance of an optical system configured to include the video element and the light guide member is represented by f and a distance from a lens principal point of the optical system to a pupil position is represented by Di, the focal distance f and the distance Di are the same or approximately the same as each other.

12. The virtual image display device according to claim 11,
wherein in the optical system configured to include the video element and the light guide member, a maximum difference in luminance of rays of the video light is within a predetermined position in a range of an angle at which the video light is emitted in the horizontal direction.

13. The virtual image display device according to claim 11,
wherein in the optical system configured to include the video element and the light guide member, when an Eyring diameter is represented by De, an angle which is formed between a normal line of the panel and an emission direction of video light in the horizontal direction is represented by θₕ, regarding luminance Iθₕ of rays which are emitted at the angle θₕ, a maximum value of the luminance of rays in the range of the Eyring diameter is represented by Iₘₐₓθₕ, a minimum value thereof is represented by Iₘᵢₙθₕ, and a maximum telecentric angle which shows non-telecentricity and is determined based on a difference between the focal distance f and the distance Di is represented by φₘₐₓ, when
$$- ( {tan}^{- 1} ( \frac{De}{2 f} ) + {φ}_{max} ) \leq {θ}_{h} \leq ( {tan}^{- 1} ( \frac{De}{2 f} ) + {φ}_{max} )$$
is satisfied,
$$\frac{( {I}_{max} {θ}_{h} - {I}_{min} {θ}_{h} )}{{I}_{max} {θ}_{h}} \leq 0.3$$
is satisfied.

14. The virtual image display device according to claim 13,
wherein in the optical system configured to include the video element and the light guide member, the focal distance f and the distance Di are the same as each other, and thus a value of the maximum telecentric angle φₘₐₓ is zero.

15. The virtual image display device according to claim 11,
wherein in the video element for a right eye and the video element for a left eye which are configured as a pair arranged in the horizontal direction, video light having light distribution characteristics which are symmetric in the horizontal direction is emitted.

16. The virtual image display device according to claim 11,
wherein the video element for a right eye and the video element for a left eye which are configured as a pair arranged in the horizontal direction are arranged centrosymmetrically in the horizontal direction.

17. The virtual image display device according to claim 1,
wherein the light guide member is a prism-type member which guides video light and allows external light to pass therethrough to allow the video light and the external light to be visually recognized.

18. The virtual image display device according to claim 1,
wherein the light guide member allows an intermediate image to be formed therein as a part of an optical system which guides the video light.
